(19) United States
(12) Patent Application Publication
(10) Pub. No.: US 2025/0083606 A1
(43) Pub. Date: Mar. 13, 2025

(54) PULL OUT STORAGE STEP

(71) Applicant: Lippert Components, Inc., Elkhart, IN (US)

(72) Inventors: Dominic LAYNE, South Bend, IN (US); John SHOTWELL, Edwardsburg, MI (US)

(21) Appl. No.: 18/884,224

(22) Filed: Sep. 13, 2024

Related U.S. Application Data
(60) Provisional application No. 63/582,389, filed on Sep. 13, 2023.

(51) Int. Cl. B60R 3/02

(52) U.S. Cl. CPC B60R 3/02

(57) ABSTRACT

A storage step stowable in a pair of storage compartment channels includes a plurality of treads including a top tread, a pair of forward stringers pivotally connected to or adjacent forward ends of the treads, and a pair of rearward stringers pivotally connected to or adjacent rearward ends of the treads. A sliding assembly coupled with the storage step is slidable in the storage compartment channels.

### CROSS-REFERENCES TO RELATED APPLICATIONS

This application claims the benefit of U.S. Provisional Patent Application No. 63/582,389, filed Sep. 13, 2023, the entire content of which is herein incorporated by reference.

### STATEMENT REGARDING FEDERALLY SPONSORED RESEARCH OR DEVELOPMENT

(NOT APPLICABLE)

### BACKGROUND

The invention relates to stowable stairs for a recreational vehicle or the like.

It is common for recreational vehicles to include elevated surfaces such as the interior of the vehicle, a fold-down patio, a trailer bed, etc., and it is desirable for the user to be able to access the elevated surfaces from the ground. Due to various size and safety regulations, as well as the height of the elevated surfaces relative to the ground, it may not be possible or practical to integrate stairs onto the exterior of the vehicle.

Removable stairs may be attached to the elevated surface to allow the user to walk up and down between the ground and the elevated surface. Removable stairs, however, can be burdensome and tend to occupy valuable storage space.

Exemplary existing step assemblies are described in U.S. Pat. Nos. 9,771,025, 10,266,121, and U.S. Publication 2019/0351832, the contents of which are hereby incorporated by reference.

### SUMMARY

Exemplary embodiments include a pull out step assembly cooperable with a storage compartment disposed within or beneath a recreational vehicle or boat or other structure. In one embodiment, stair treads are secured between forward and rearward stringers, and in a stowed position, the stringers overlay each other and the treads are pivoted into a common plane. A sliding assembly enables the storage step in its stowed position to be secured within storage compartment channels.

A motor may be coupled with the assembly to displace the stringers and treads between a storage position within the storage compartment channels and a use position extended out of the storage compartment channels. In the use position, the stringers can pivot relative to the sliding assembly by gravity to thereby orient the treads for use.

A locking mechanism may be cooperable with the storage step components to selectively lock the storage step in its deployed position or its stowed position.

In an exemplary embodiment, a storage step stowable in a pair of storage compartment channels includes a plurality of treads including a top tread, a pair of forward stringers pivotally connected to or adjacent forward ends of the treads, a pair of rearward stringers pivotally connected to or adjacent rearward ends of the treads, and a sliding assembly coupled with the storage step and slidable in the storage compartment channels.

The treads, the forward stringers, and the rearward stringers may be displaceable between a deployed position in which the treads are oriented for use and a stowed position in which the treads are pivoted into a common plane. In stowed position, the forward stringers may overlay the rearward stringers.

The sliding assembly may include end brackets connected to the top tread at one end of the end brackets and sliders connected at an opposite end of the end brackets. The sliders may include a tube with an outer perimeter shaped in complement to an inner perimeter of the storage compartment channels. The sliding assembly may further include friction-reducing elements disposed on an exterior of the sliders. The end brackets may be interposed between the forward and rearward stringers and outer edges of the top tread. The sliding assembly may further include a slider hard stop fixed on an interior surface of the sliders. The sliding assembly may further include a cross bar connected between the sliders.

At least one of the pair of forward stringers and the pair of rearward stringers may include ground engaging feet at distal ends thereof.

In some embodiments, only the pair of forward stringers may include ground engaging feet at distal ends thereof.

The storage step may further include a motor coupled with at least one of the pair of forward stringers and the pair of rearward stringers. In this context, the motor may be configured to displace the pair of forward stringers and the pair of rearward stringers between a storage position in which the treads, the forward stringers and the rearward stringers are contained in the storage compartment channels and a use position in which the treads, the forward stringers and the rearward stringers are extended out of the storage compartment channels. In the use position, the forward and rearward stringers may pivot relative to the sliding assembly by gravity, and the rearward stringers may pivot relative to the forward stringers by gravity, thereby orienting the treads for use. The storage step may further include a linkage plate connected between forward end of the top tread to a back end of a subsequent lower tread.

The treads, the forward stringers, and the rearward stringers may be displaceable between a deployed position in which the treads are oriented for use and a stowed position in which the treads are pivoted into a common plane. In this context, the storage step may additionally include a locking mechanism cooperable with at least one of (1) the treads and (2) the forward and rearward stringers, where the locking mechanism is configured to selectively lock the storage step in the deployed position or the stowed position. The locking mechanism may include a spring-loaded lever engaging a propping bar and a release lever coupled to the spring-loaded lever, where actuation of the release lever disengages the spring-loaded lever from the propping bar to release the locking mechanism. The locking mechanism may include a detent lever that is displaceable with one of the rearward stringers and engages a detent plate connected to one of the treads, where the detent lever engages teeth of the detent plate to secure the locking mechanism.

The sliding assembly may include a U-shaped frame, and a tread below the top tread may be fixed in the U-shaped frame. The treads, the forward stringers, and the rearward stringers may be displaceable between a deployed position in which the treads are oriented for use and a stowed position in which the treads are pivoted into a common plane. In the deployed position, the top tread may be pivoted by the forward stringers and the rearward stringers to a position above the U-shaped frame.

In another exemplary embodiment, a storage step stowable in a pair of storage compartment channels includes a plurality of treads including a top tread, a forward stringer pivotally connected to or adjacent forward ends of the treads, a rearward stringer pivotally connected to or adjacent rearward ends of the treads, and a sliding assembly coupled with the top tread and slidable in the storage compartment channels. The treads, the forward stringer, and the rearward stringer are displaceable between a deployed position in which the treads are oriented for use and a stowed position in which the treads are pivoted into a common plane. The treads, the forward stringer, and the rearward stringer are displaceable between a storage position in which the treads, the forward stringer and the rearward stringer are contained in the storage compartment channels and a use position in which the treads, the forward stringer and the rearward stringer are extended out of the storage compartment channels.

### BRIEF DESCRIPTION OF THE DRAWINGS

These and other aspects and advantages will be described in detail with reference to the accompanying drawings, in which:

FIG. 1 is a perspective view of the storage step in a deployed or use position;

FIG. 2 shows the step assembly in a stowed position;

FIG. 3 is a close-up view of the top tread and sliding assembly;

FIG. 4 is a close-up view of a bottom portion of the storage step in a stowed position;

FIG. 5 shows a variation with motorized deployment and stowage in a stowed position;

FIG. 6 shows the variation of FIG. 5 in a deployed position;

FIG. 7 shows a variation including a locking mechanism with the assembly in a use position;

FIG. 8 shows the FIG. 7 variation in a collapsed position ready to be stowed;

FIGS. 9 and 10 are close-up views of an exemplary locking mechanism in the use position and the collapsed position, respectively;

FIG. 11 shows an underside of the FIG. 7 variation;

FIG. 12 shows a further variation using a ratchet lever;

FIG. 13 shows an exemplary locking mechanism for use with a deployable foot pad;

FIG. 14 shows a further variation of the storage step with the sliding assembly connected to front and rear stringers; and

FIGS. 15-17 show various actuation mechanisms for a storage step.

### DETAILED DESCRIPTION

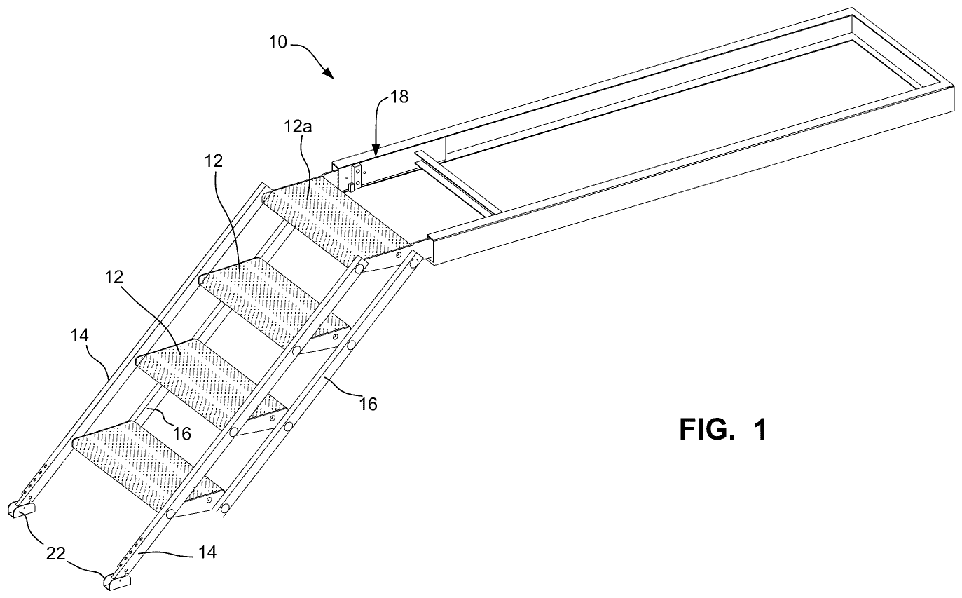

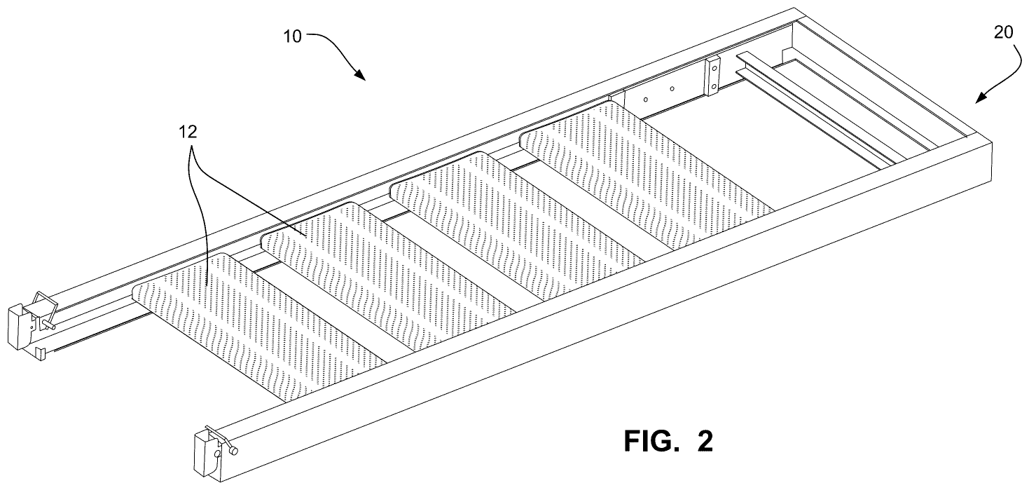

With reference to FIGS. 1-4, a pull out storage step 10 includes a plurality of treads 12. A top tread is designated with reference 12a. The storage step 10 also includes a pair of forward stringers 14 pivotally connected to or adjacent forward ends of the treads 12 and a pair of rearward stringers 16 pivotally connected to or adjacent rearward ends of the treads 12. A sliding assembly 18 is coupled with the storage step 10 and is slidable in storage compartment channels 20. Storage compartment channels 20 enclosing the storage step 10 may be mounted or secured to the underside of an RV chassis or boat frame or may be installed within the interior of an RV chassis. The treads 12, the forward stringers 14, and the rearward stringers 16 are displaceable between a deployed position shown in FIG. 1 in which the treads 12 are oriented for use, and a stowed position shown in FIG. 2 in which the treads 12 are pivoted into a common plane and slid into the storage compartment channels 20. In some embodiments such as FIGS. 1-3, the sliding assembly 18 is coupled with the top tread 12a. In other embodiments, the sliding assembly 18 may be coupled elsewhere to the storage step

The forward stringers 14 and the rearward stringers 16 are pivotally connected at a single point at respective front and back ends of each tread 12. In the collapsed or stowed position, the forward stringers 14 overlay the rearward stringers 16 to fit within the storage compartment channels 20.

In some embodiments, one of the forward or rearward stringers 14, 16 on both sides of the treads 12 may be shorter than the other of the forward and rearward stringers 14, 16 so that the shorter stringers do not touch the ground. In this context, only one set of stringers on both sides of the treads 12 may secure a pivoting foot 22 for engaging the ground.

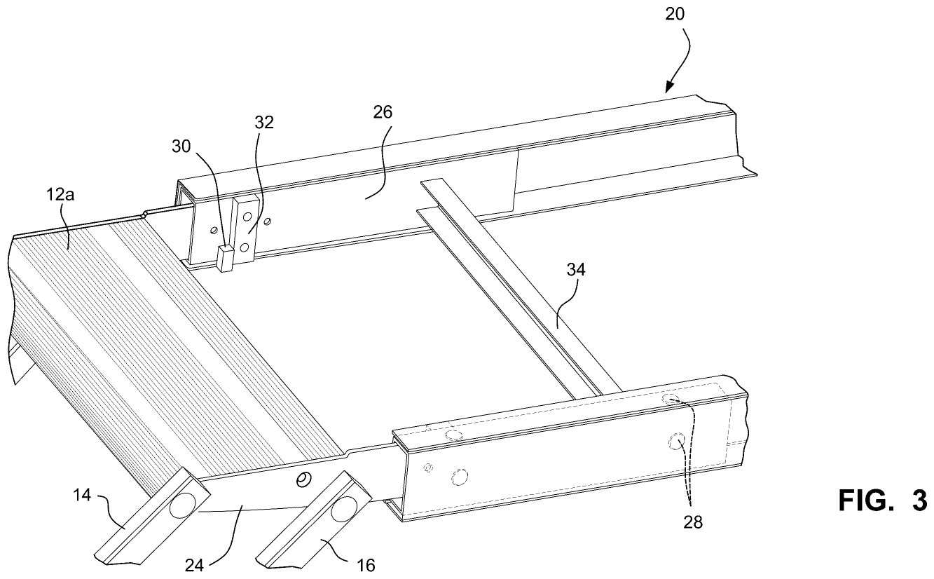

The sliding assembly 18 includes end brackets 24 connected preferably to a tread 12 at one end thereof and sliders 26 connected at an opposite end thereof. As shown in FIGS. 1 and 3, the end brackets 24 of the sliding assembly 18 may be connected to the top tread 12a. More specifically, the end brackets 24 include a distal end connecting the upper end of each of the forward and rearward stringers 14, 16. The end brackets 24 are interposed between the forward and rearward stringers 14, 16 and outer edges of the top tread 12a. The proximal end of the end brackets 24 is secured or welded to the sliders 26 in association with the storage compartment channels 20.

The sliders 26 may be in the form of a tube (e.g., an aluminum tube) with an outer perimeter shaped in complement to an inner perimeter of the storage compartment channels 20. Friction reducing elements such as wear tabs 28 may be disposed on an exterior of the sliders 26, and the sliders 26 slide relative to the storage compartment channels 20. In other embodiments, the sliders 26 may include wear strips, wear channels, or other friction-reducing material to facilitate sliding within the storage compartment channels 20.

A channel hard stop 30 is welded or otherwise secured to the storage compartment channel 20 to engage a bolt-on or otherwise secured slider hard stop 32 that moves with the slider 26 to prevent overextension of the assembly or unintentional removal of the step from the storage compartment channels 20.

A cross bar 34 may be provided to tie the two sliders 26 together to help prevent binding when pulling the step assembly out or pushing the step assembly in.

The storage step is suited for a recreational vehicle or the like as an entry step and can be mounted through a hole in the vehicle frame or may be mounted completely under the frame.

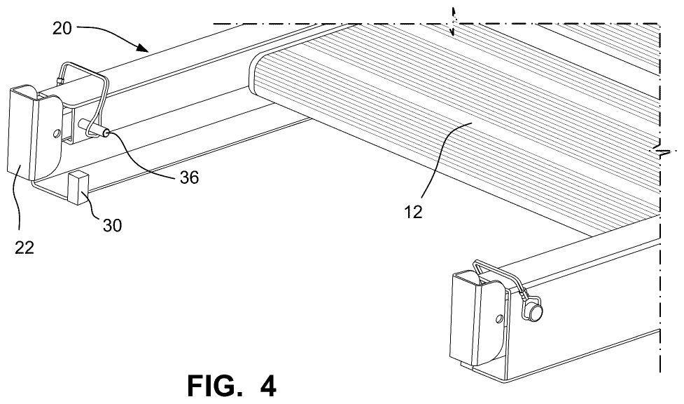

In use, from the configuration shown in FIG. 1, a user simply grasps the front stringers 14 of the storage step 10 and pulls upwardly so that all four stringers 14, 16 are horizontal and stack on each side. This movement along with the sliding assembly 18 at the top end of the step assembly allow the step assembly to slide in and out of the storage compartment channels 20 in an easy and compact manner. The assembly may also include a lock pin 36 (FIG. 4) securable through the storage compartment channels 20 and the forward stringers 14 with the assembly in the fully stowed position.

Deploying the storage step 10 is equally simplified as the user simply pulls the step assembly from the storage compartment channels 20, and the assembly will pivot by gravity into the position and orientation shown in FIG. 1. Stowage and deployment could also be automated with a motor configured to drive the forward and rearward stringers 14, 16 between stowed and deployed positions.

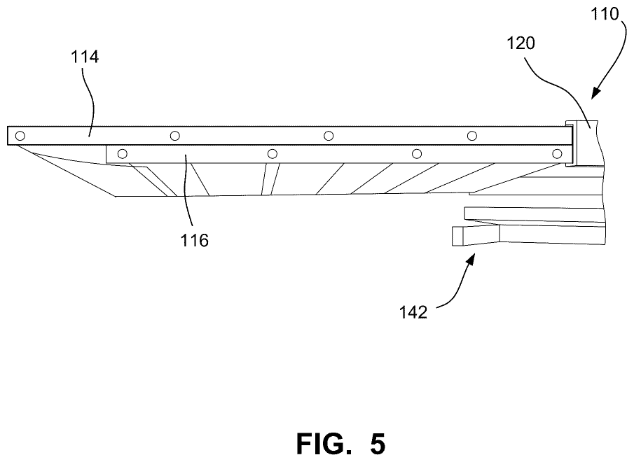

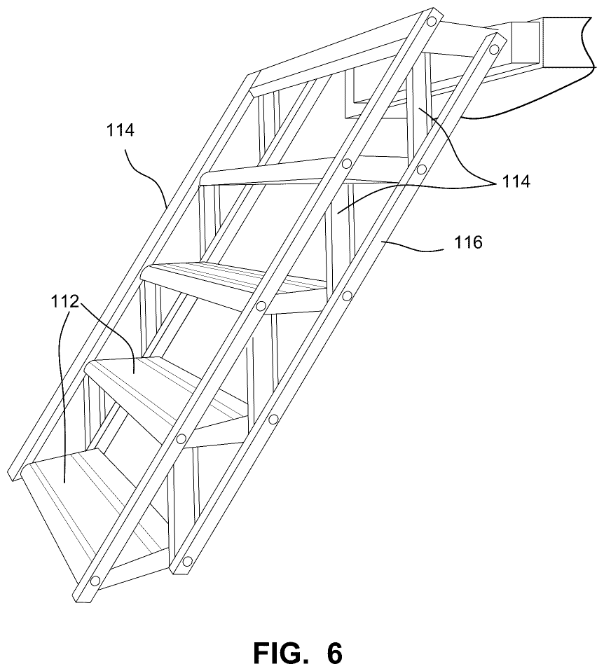

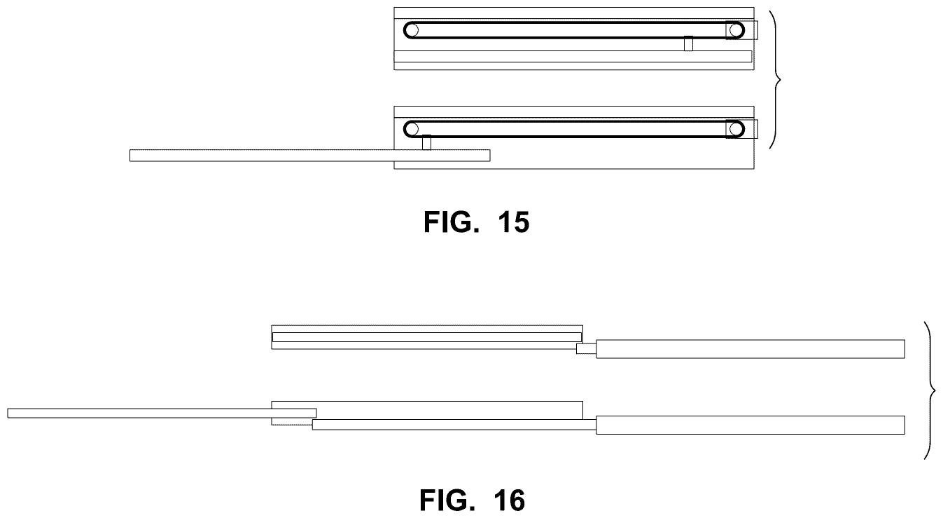

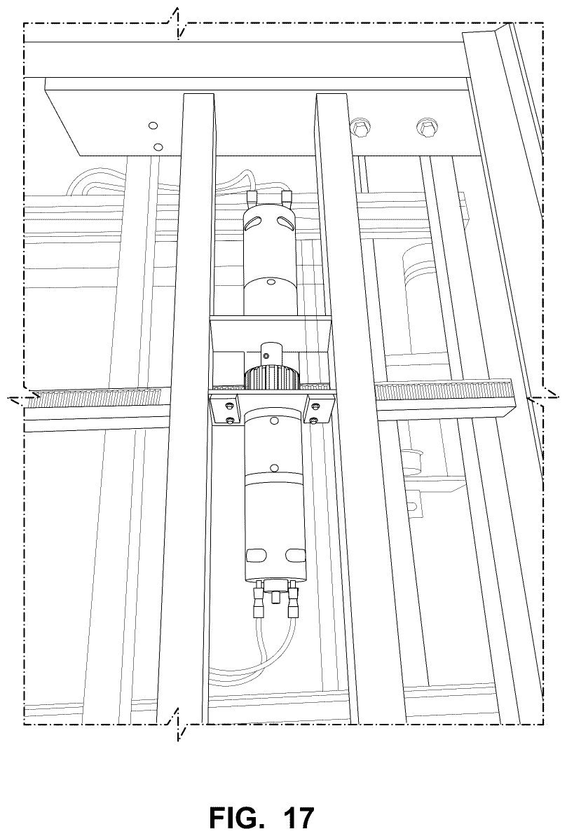

An exemplary configuration utilizing a motor for deployment and stowage is shown in FIGS. 5-6. Various non-limiting actuation systems for deploying and stowing a storage step are shown in FIGS. 15-17. These include but are not limited to a belt and pulley system (FIG. 15), a hydraulic cylinder (FIG. 16), and a rack and pinion system (FIG. 17). The storage step 110 includes a motor 142 coupled with at least one of the pair of forward stringers 114 and the pair of rearward stringers 116. The motor 142 is configured to displace the pair of forward stringers 114 and the pair of rearward stringers 116 between a storage position in which the treads 112, the forward stringers 114 and the rearward stringers 116 are contained in the storage compartment channels 120, and a use position in which the treads 112, the forward stringers 114 and the rearward stringers 116 are extended out of the storage compartment channels 120. In the use position, the forward and rearward stringers 114, 116 pivot relative to the sliding assembly by gravity, and the rearward stringers 116 pivot relative to the forward stringers 114 by gravity, thereby orienting the treads 112 for use. The step assembly is extended by the motor 142 from the storage compartment channels 120 to the position in FIG. 5, and the assembly assumes the position in FIG. 6 by gravity.

Linkage plates 144 are connected between the forward end of one tread 112 to a back end of a subsequent lower tread 112. A slot may be included in the linkage plates 144 to assist in deployment of the step assembly as the front and rear stringers 114, 116 move apart with gravity. The slotted linkage plates 144 define a hard stop so the treads 112 stop at a certain angle.

In some embodiments, the motorized version shown in FIGS. 5-6 is without ground-engaging feet and rather suspends from the storage compartment channels 120. The linkage plates 144 help prevent the whole assembly from flexing when walking on the steps, especially where there is not a ground-engaging component.

In some embodiments, the motorized variation is suited for boat or pontoon applications where there is no ‘ground’ to engage and/or the ground is not easily accessible for manual deployment. The storage compartment channels 120 may be mounted completely under the chassis/boat frame, preferably to aluminum crossmembers on the underside of the pontoon deck.

The storage compartment channels 120 may include a ramped decline at the end of the compartment channel opening.

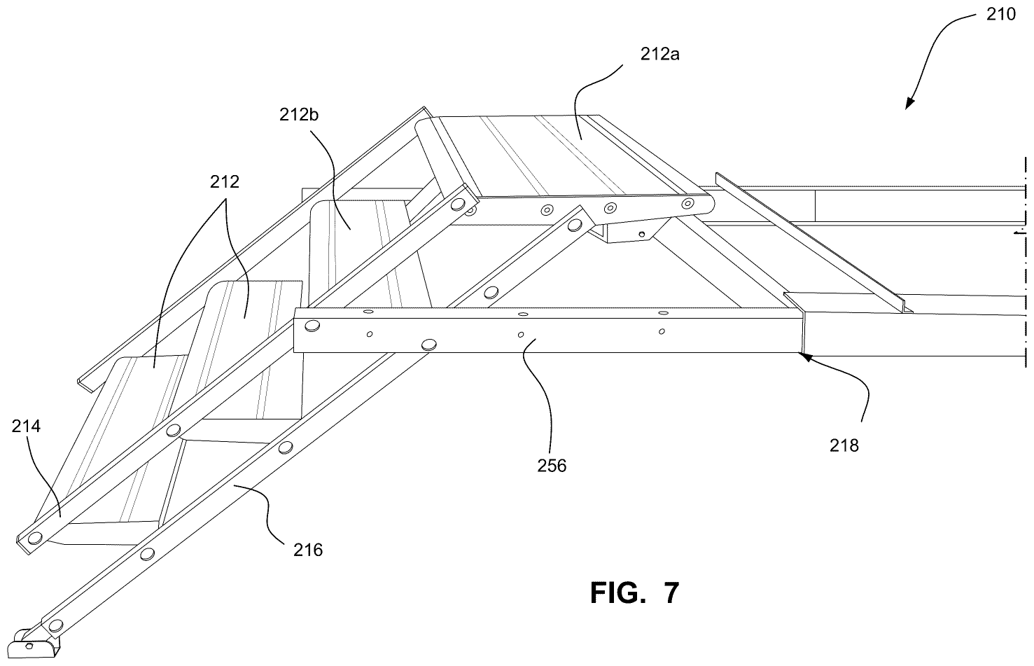

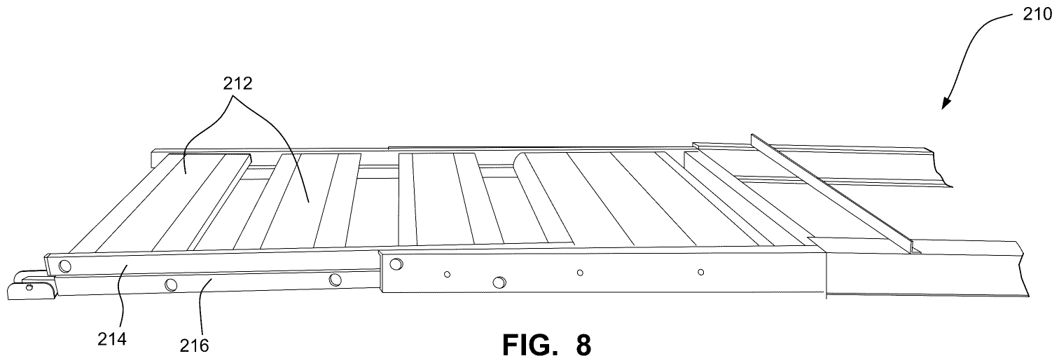

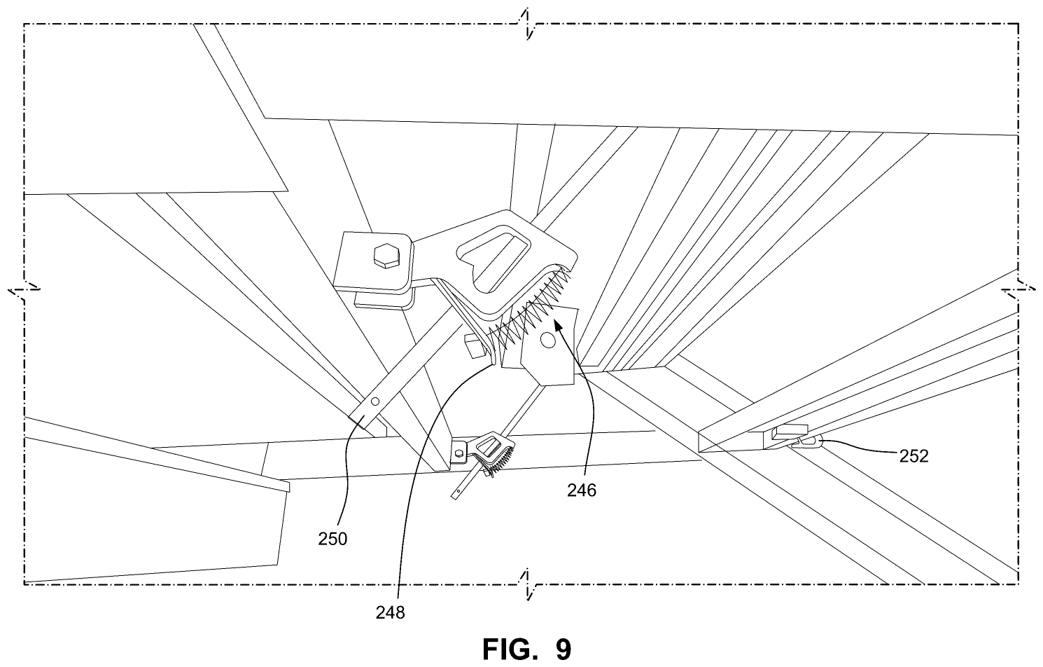

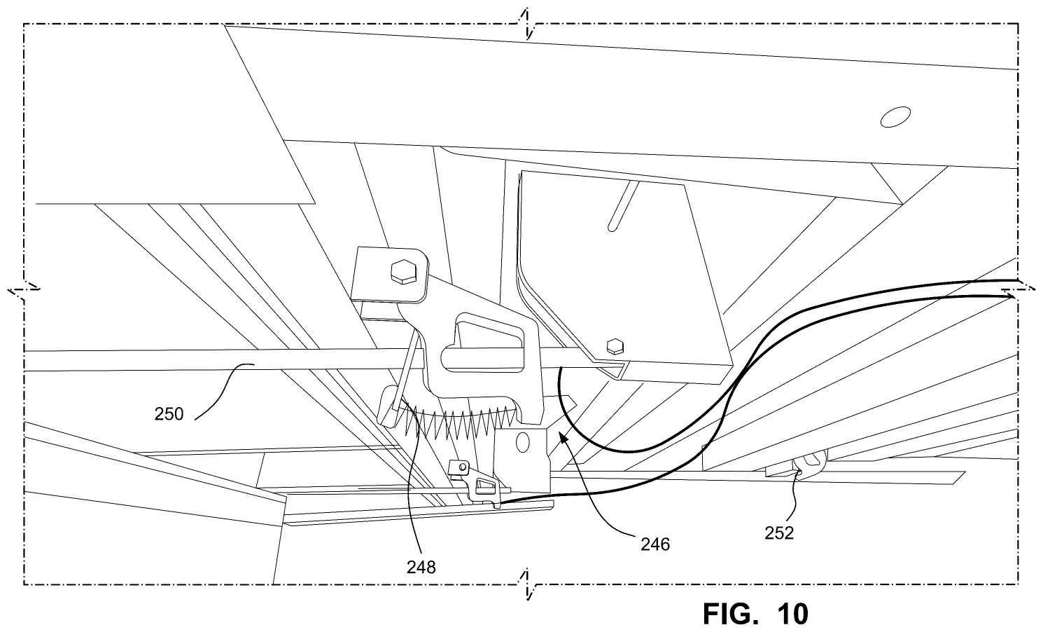

FIGS. 7-11 show a variation of an undermount pull out storage step 210. The storage step 210 may be mounted under the I-beam of the vehicle chassis. A locking mechanism 246 (FIGS. 9-11) is cooperable with the treads 212 and/or one or both of the forward and rearward stringers 214, 216. The locking mechanism 246 is configured to selectively lock the storage step in the deployed position shown in FIG. 7 or the stowed position shown in FIG. 8.

In some embodiments, the locking mechanism 246 includes a spring-loaded lever 248 engaging a propping bar 250 and a release lever 252 coupled to the spring-loaded lever 248. Actuation of the release lever 252 disengages the spring-loaded lever 248 from the propping bar 250 to release the locking mechanism 246. The locking mechanism 246 works similar to a bar clamp. The spring-loaded lever 248 allows the propping bar 250 to move one direction and prevents the bar 250 from going the other direction unless the spring-loaded lever 248 is released. The release lever 252 disposed on one of the lower steps is actuated to compress the springs connected to the spring-loaded lever 248, which allows for the propping bar 250 to slide downward and into a horizontal position to put the step assembly in the horizontal stowed position.

When the step assembly is in the stowed position, because of the propping bar 250 being perpendicular to the deployment direction of where the step assembly is trying to travel, the step assembly is locked, and the release lever 252 needs to once again be actuated before being able to deploy the step assembly. Once the propping bar 250 breaks the horizontal plane, or is no longer perpendicular with the deployment motion, the release lever 252 can be released and the step assembly can be deployed.

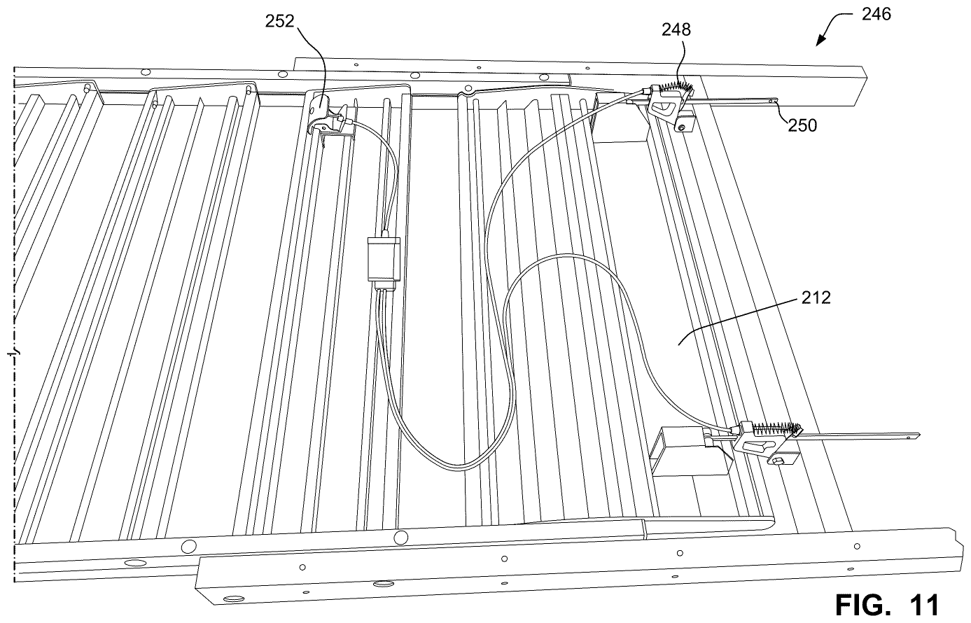

As shown in FIG. 11, the storage step may incorporate two of the spring-loaded lever 248 and the propping bar 250 adjacent opposite sides of the tread 212.

With continued reference to FIGS. 7 and 8, the sliding assembly 218 in this variation may include a U-shaped frame 256. A tread 212b below the top tread 212a is fixed in the U-shaped frame 256. The treads 212, the forward stringers 214, and the rearward stringers 216 are pivotable around the fixed tread 212b relative to the U-shaped frame 256 between a deployed position in which the treads 212 are oriented for use and a stowed position in which the treads 212 are pivoted into a common plane. In the deployed position, the top tread 212a is pivoted by the forward stringers 214 and the rearward stringers 216 to a position above the U-shaped frame 256 as shown in FIG. 7. That is, when deploying the steps, the top tread 212a pops up above the U-shaped frame 256 while the remaining treads 212 below the fixed tread 212b are lowered to the ground.

In this embodiment, when the step is deployed, the top tread 212a is locked via the locking mechanism 246 to prevent the steps from closing as a user steps on the top step.

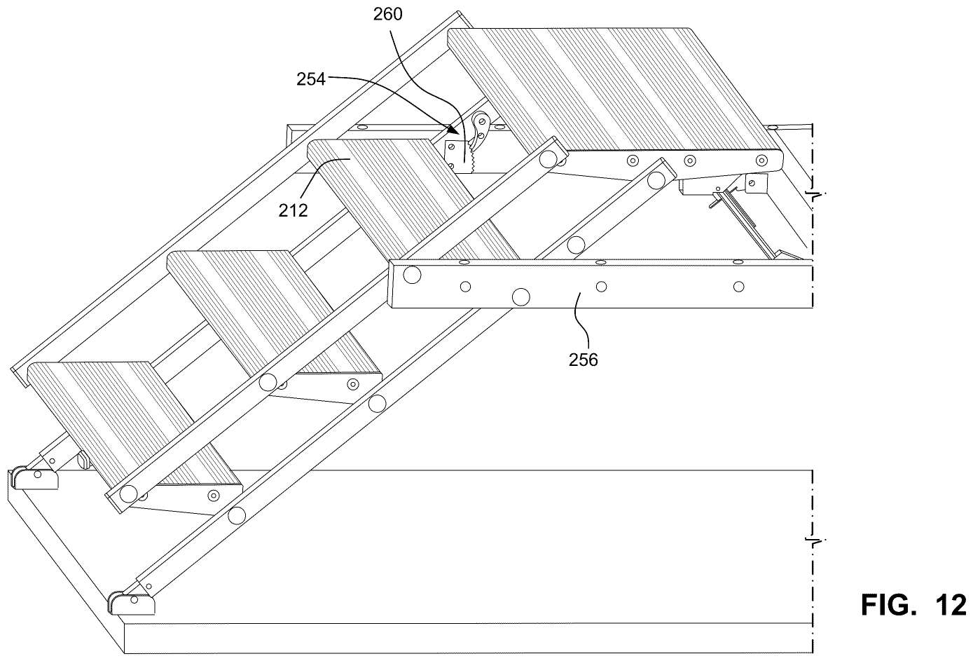

As shown in FIG. 12, locking mechanism 246 may alternatively include a detent lever 254 that is displaceable with one of the rearward stringers and engages a detent plate 260 connected to one of the treads 212. The detent lever 254 engages teeth of the detent plate 260 to secure the locking mechanism. The detent lever 254 may be located either on the fixed tread 212b or on the tread below the fixed tread 212b.

As shown in FIG. 13, a pivoting foot or footpad 380 may be connected to a sliding leg 382 connected to each of a pair of forward stringers 314 or rearward stringers 316 of the storage step assembly 310 and may be adjustably deployed from the stringers 314, 316 by a locking mechanism 346 similar to the locking mechanism 246 described above. In this locking mechanism 346, a spring-loaded lever 348 connected to the stringer 314, 316 may be compressed to allow the sliding leg 382 with the foot 380 to adjustably slide from the stringer to a desired position relative to the stringer. The lever 348 is then released to engage and lock the sliding leg 382 in place. In this manner, the sliding leg 382 may be locked at any place along the length of the sliding leg.

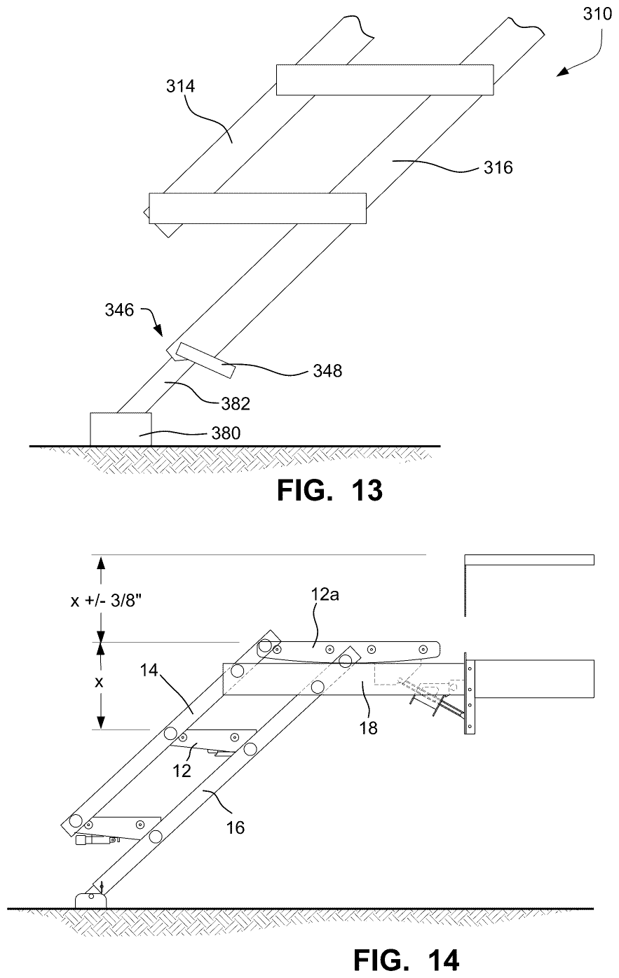

As shown in FIG. 14, the sliding assembly 18 may mount to the front stringers 14 and rear stringers 16 directly. In this embodiment, the sliding assembly 18 may not mount to any part of any tread 12.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A storage step stowable in a pair of storage compartment channels, the storage step comprising:
a plurality of treads including a top tread;
a pair of forward stringers pivotally connected to or adjacent forward ends of the treads;
a pair of rearward stringers pivotally connected to or adjacent rearward ends of the treads; and
a sliding assembly coupled with the storage step and slidable in the storage compartment channels.

2. A storage step according to claim 1, wherein the treads, the forward stringers, and the rearward stringers are displaceable between a deployed position in which the treads are oriented for use and a stowed position in which the treads are pivoted into a common plane.

3. A storage step according to claim 2, wherein in the stowed position, the forward stringers overlay the rearward stringers.

4. A storage step according to claim 1, wherein the sliding assembly comprises end brackets connected to the top tread at one end of the end brackets and sliders connected at an opposite end of the end brackets.

5. A storage step according to claim 4, wherein the sliders comprise a tube with an outer perimeter shaped in complement to an inner perimeter of the storage compartment channels.

6. A storage step according to claim 5, wherein the sliding assembly further comprises friction-reducing elements disposed on an exterior of the sliders.

7. A storage step according to claim 4, wherein the end brackets are interposed between the forward and rearward stringers and outer edges of the top tread.

8. A storage step according to claim 4, wherein the sliding assembly further comprises a slider hard stop fixed on an interior surface of the sliders.

9. A storage step according to claim 4, wherein the sliding assembly further comprises a cross bar connected between the sliders.

10. A storage step according to claim 1, wherein at least one of the pair of forward stringers and the pair of rearward stringers comprises ground engaging feet at distal ends thereof.

11. A storage step according to claim 1, wherein only the pair of forward stringers comprises ground engaging feet at distal ends thereof.

12. A storage step according to claim 1, further comprising a motor coupled with at least one of the pair of forward stringers and the pair of rearward stringers, wherein the motor is configured to displace the pair of forward stringers and the pair of rearward stringers between a storage position in which the treads, the forward stringers and the rearward stringers are contained in the storage compartment channels and a use position in which the treads, the forward stringers and the rearward stringers are extended out of the storage compartment channels, and wherein in the use position, the forward and rearward stringers pivot relative to the sliding assembly by gravity, and the rearward stringers pivot relative to the forward stringers by gravity, thereby orienting the treads for use.

13. A storage step according to claim 12, further comprising a linkage plate connected between forward end of the top tread to a back end of a subsequent lower tread.

14. A storage step according to claim 1, wherein the treads, the forward stringers, and the rearward stringers are displaceable between a deployed position in which the treads are oriented for use and a stowed position in which the treads are pivoted into a common plane, the storage step further comprising a locking mechanism cooperable with at least one of (1) the treads and (2) the forward and rearward stringers, the locking mechanism being configured to selectively lock the storage step in the deployed position or the stowed position.

15. A storage step according to claim 14, wherein the locking mechanism comprises a spring-loaded lever engaging a propping bar and a release lever coupled to the spring-loaded lever, wherein actuation of the release lever disengages the spring-loaded lever from the propping bar to release the locking mechanism.

16. A storage step according to claim 14, wherein the locking mechanism comprises a detent lever that is displaceable with one of the rearward stringers and engages a detent plate connected to one of the treads, the detent lever engaging teeth of the detent plate to secure the locking mechanism.

17. A storage step according to claim 1, wherein the sliding assembly comprises a U-shaped frame, and wherein a tread below the top tread is fixed in the U-shaped frame, the treads, the forward stringers, and the rearward stringers being displaceable between a deployed position in which the treads are oriented for use and a stowed position in which the treads are pivoted into a common plane, wherein in the deployed position, the top tread is pivoted by the forward stringers and the rearward stringers to a position above the U-shaped frame.

18. A storage step stowable in a pair of storage compartment channels, the storage step comprising:
a plurality of treads including a top tread;
a forward stringer pivotally connected to or adjacent forward ends of the treads;
a rearward stringer pivotally connected to or adjacent rearward ends of the treads; and
a sliding assembly coupled with the top tread and slidable in the storage compartment channels,
wherein the treads, the forward stringer, and the rearward stringer are displaceable between a deployed position in which the treads are oriented for use and a stowed position in which the treads are pivoted into a common plane, and
wherein the treads, the forward stringer, and the rearward stringer are displaceable between a storage position in which the treads, the forward stringer and the rearward stringer are contained in the storage compartment channels and a use position in which the treads, the forward stringer and the rearward stringer are extended out of the storage compartment channels.

19. A storage step according to claim 18, wherein in the use position, the forward and rearward stringers pivot relative to the sliding assembly, and the rearward stringer pivots relative to the forward stringer, thereby orienting the treads for use.
